(19) United States
(12) Patent Application Publication
(10) Pub. No.: US 2014/0240215 A1
(43) Pub. Date: Aug. 28, 2014

(54) SYSTEM AND METHOD FOR CONTROLLING A USER INTERFACE UTILITY USING A VISION SYSTEM

(71) Applicant: COREL CORPORATION, Ottawa (CA)

(72) Inventors: Christopher J. Tremblay, Cantley (CA); Stephen P. Bolt, Stittsville (CA)

(73) Assignee: Corel Corporation, Ottawa (CA)

(21) Appl. No.: 13/777,636

(22) Filed: Feb. 26, 2013

(51) Int. Cl. G06T 11/20

(52) U.S. Cl. CPC G06T 11/20
USPC 345/156

(57) ABSTRACT

A method for controlling a user interface utility in a graphics application program executing on a computer is disclosed. The method includes a step of connecting a vision system to the computer, wherein the vision system is adapted to monitor a visual space. The method further includes a step of detecting, by the vision system, a tracking object in the visual space. The method further includes a step of executing, by the computer, a graphics application program, and outputting, by the vision system to the computer, spatial coordinate data representative of the location of the tracking object within the visual space. The method further includes a step of controlling, with the spatial coordinate data output by the vision system, the rendering of a user interface utility within the graphics application program to a display connected to the computer.

### FIELD OF THE INVENTION

This disclosure relates generally to graphic computer software systems and, more specifically, to a system and method for creating computer graphics and artwork with a vision system.

### BACKGROUND OF THE INVENTION

Graphic software applications provide users with tools for creating drawings for presentation on a display such as a computer monitor or tablet. One such class of applications includes painting software, in which computer-generated images simulate the look of handmade drawings or paintings. Graphic software applications such as painting software can provide users with a variety of drawing tools, such as brush libraries, chalk, ink, and pencils, to name a few. In addition, the graphic software application can provide a ‘virtual canvas’ on which to apply the drawing or painting. The virtual canvas can include a variety of simulated textures.

To create or modify a drawing, the user selects an available input device and opens a drawing file within the graphic software application. Traditional input devices include a mouse, keyboard, or pressure-sensitive tablet. The user can select and apply a wide variety of media to the drawing, such as selecting a brush from a brush library and applying colors from a color panel, or from a palette mixed by the user. Media can also be modified using an optional gradient, pattern, or clone. The user then creates the graphic using a ‘start stroke’ command and a ‘finish stroke’ command. In one example, contact between a stylus and a pressure-sensitive tablet display starts the brushstroke, and lifting the stylus off the tablet display finishes the brushstroke. The resulting rendering of any brushstroke depends on, for example, the selected brush category (or drawing tool); the brush variant selected within the brush category; the selected brush controls, such as brush size, opacity, and the amount of color penetrating the paper texture; the paper texture; the selected color, gradient, or pattern; and the selected brush method.

As the popularity of graphic software applications flourish, new groups of drawing tools, palettes, media, and styles are introduced with every software release. As the choices available to the user increase, so does the complexity of the user interface menu. Graphical user interfaces (GUIs) have evolved to assist the user in the complicated selection processes. However, with the ever-increasing number of choices available, even navigating the GUIs has become time-consuming, and may require a significant learning curve to master. In addition, the GUIs can occupy a significant portion of the display screen, thereby decreasing the size of the virtual canvas.

### SUMMARY OF THE INVENTION

In one aspect of the invention, a method for controlling a user interface utility in a graphics application program executing on a computer is disclosed. The method includes a step of connecting a vision system to the computer, wherein the vision system is adapted to monitor a visual space. The method further includes a step of detecting, by the vision system, a tracking object in the visual space. The method further includes a step of executing, by the computer, a graphics application program, and outputting, by the vision system to the computer, spatial coordinate data representative of the location of the tracking object within the visual space. The method further includes a step of controlling, with the spatial coordinate data output by the vision system, the rendering of a user interface utility within the graphics application program to a display connected to the computer.

In another aspect of the invention, a graphic computer software system includes a computer comprising one or more processors, one or more computer-readable memories, one or more computer-readable tangible storage devices, and program instructions stored on at least one of the one or more storage devices for execution by at least one of the one or more processors via at least one of the one or more memories. The graphic computer software system further includes a display connected to the computer, a tracking object, and a vision system connected to the computer. The vision system includes one or more image sensors adapted to capture the location of the tracking object within a visual space. The vision system is adapted to output to the computer spatial coordinate data representative of the location of the tracking object within the visual space. The computer program instructions include program instructions to execute a graphics application program and output to the display, and program instructions to control the rendering of a user interface utility within the graphics application program using the spatial coordinate data output by the vision system.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a functional block diagram of a graphic computer software system according to one embodiment of the present invention;

FIG. 2 depicts a perspective schematic view of the graphic computer software system of FIG. 1;

FIG. 3 depicts a perspective schematic view of the graphic computer software system shown in FIG. 1 according to another embodiment of the present invention;

FIG. 4 depicts a perspective schematic view of the graphic computer software system shown in FIG. 1 according to yet another embodiment of the present invention;

FIG. 5 depicts a schematic front plan view of the graphic computer software system shown in FIG. 1;

FIG. 6 depicts another schematic front plan view of the graphic computer software system shown in FIG. 1;

FIG. 7 depicts a schematic top view of the graphic computer software system shown in FIG. 1;

FIG. 8 depicts an enlarged view of the graphic computer software system shown in FIG. 7;

FIG. 9 depicts an application window within the graphics application program of the graphic computer software system shown in FIG. 1;

FIG. 10 depicts a schematic perspective view of a user interface utility according to one embodiment of the invention;

FIG. 11 depicts a schematic perspective view of another user interface utility according to another embodiment of the invention;

FIG. 12 depicts a schematic perspective view of yet another user interface utility according to an embodiment of the invention; and

FIG. 13 depicts a schematic perspective view of color space user interface utility according to an embodiment of the invention.

### DETAILED DESCRIPTION OF THE INVENTION

According to various embodiments of the present invention, a graphic computer software system provides a solution to the problems noted above. The graphic computer software system includes a vision system as an input device to track the motion of an object in the vision system's field of view. The output of the vision system is translated to a format compatible with the input to a graphics application program. The object's motion can be used to create brushstrokes, control drawing tools and attributes, and control a palette, for example. As a result, the user experience is more natural and intuitive, and does not require a long learning curve to master.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Program code embodied on a computer-readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as PHP, Javascript, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

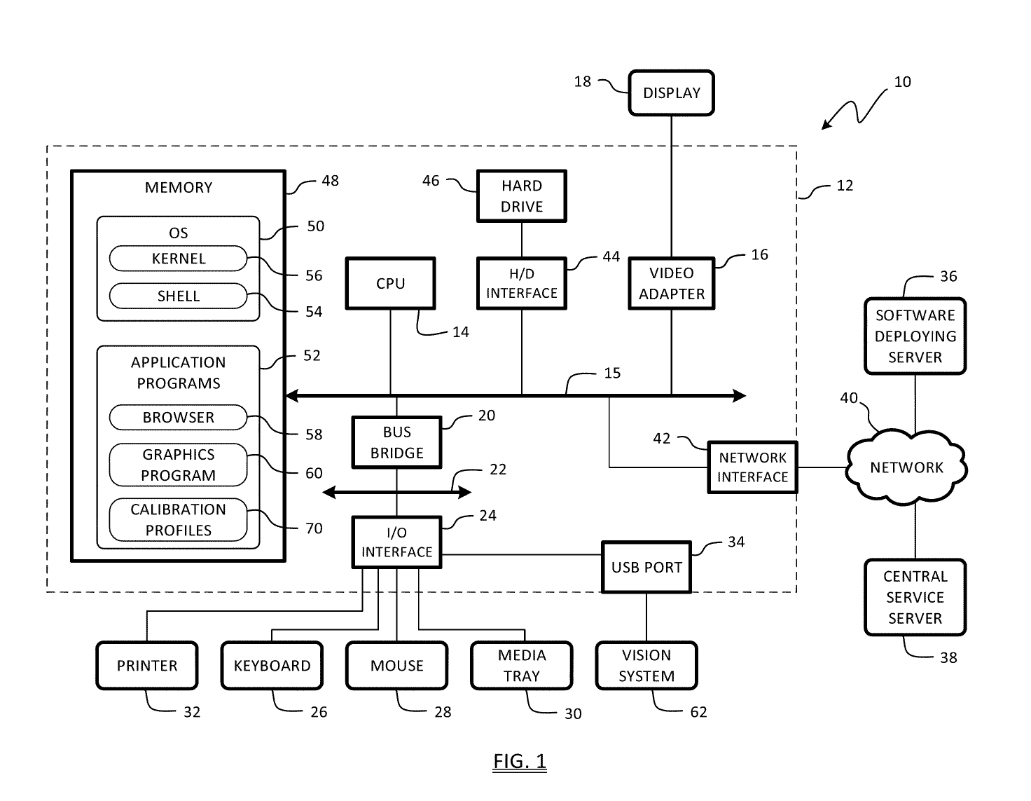

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a block diagram of a graphic computer software system 10 according to one embodiment of the present invention. The graphic computer software system 10 includes a computer 12 having a computer readable storage medium which may be utilized by the present disclosure. The computer is suitable for storing and/or executing computer code that implements various aspects of the present invention. Note that some or all of the exemplary architecture, including both depicted hardware and software, shown for and within computer 12 may be utilized by a software deploying server and/or a central service server.

Computer 12 includes a processor (or CPU) 14 that is coupled to a system bus 15. Processor 14 may utilize one or more processors, each of which has one or more processor cores. A video adapter 16, which drives/supports a display 18, is also coupled to system bus 15. System bus 15 is coupled via a bus bridge 20 to an input/output (I/O) bus 22. An I/O interface 24 is coupled to (I/O) bus 22. I/O interface 24 affords communication with various I/O devices, including a keyboard 26, a mouse 28, a media tray 30 (which may include storage devices such as CD-ROM drives, multi-media interfaces, etc.), a printer 32, and external USB port(s) 34. While the format of the ports connected to I/O interface 24 may be any known to those skilled in the art of computer architecture, in a preferred embodiment some or all of these ports are universal serial bus (USB) ports.

As depicted, computer 12 is able to communicate with a software deploying server 36 and central service server 38 via network 40 using a network interface 42. Network 40 may be an external network such as the Internet, or an internal network such as an Ethernet or a virtual private network (VPN).

A storage media interface 44 is also coupled to system bus 15. The storage media interface 44 interfaces with a computer readable storage media 46, such as a hard drive. In a preferred embodiment, storage media 46 populates a computer readable memory 48, which is also coupled to system bus 14. Memory 48 is defined as a lowest level of volatile memory in computer 12. This volatile memory includes additional higher levels of volatile memory (not shown), including, but not limited to, cache memory, registers and buffers. Data that populates memory 48 includes computer 12's operating system (OS) 50 and application programs 52.

Operating system 50 includes a shell 54, for providing transparent user access to resources such as application programs 52. Generally, shell 54 is a program that provides an interpreter and an interface between the user and the operating system. More specifically, shell 54 executes commands that are entered into a command line user interface or from a file. Thus, shell 54, also called a command processor, is generally the highest level of the operating system software hierarchy and serves as a command interpreter. The shell 54 provides a system prompt, interprets commands entered by keyboard, mouse, or other user input media, and sends the interpreted command(s) to the appropriate lower levels of the operating system (e.g., a kernel 56) for processing. Note that while shell 54 is a text-based, line-oriented user interface, the present disclosure will equally well support other user interface modes, such as graphical, voice, gestural, etc.

As depicted, operating system (OS) 50 also includes kernel 56, which includes lower levels of functionality for OS 50, including providing essential services required by other parts of OS 50 and application programs 52, including memory management, process and task management, disk management, and mouse and keyboard management.

Application programs 52 include a renderer, shown in exemplary manner as a browser 58. Browser 58 includes program modules and instructions enabling a world wide web (WWW) client (i.e., computer 12) to send and receive network messages to the Internet using hypertext transfer protocol (HTTP) messaging, thus enabling communication with software deploying server 36 and other described computer systems.

The hardware elements depicted in computer 12 are not intended to be exhaustive, but rather are representative to highlight components useful by the present disclosure. For instance, computer 12 may include alternate memory storage devices such as magnetic cassettes (tape), magnetic disks (floppies), optical disks (CD-ROM and DVD-ROM), and the like. These and other variations are intended to be within the spirit and scope of the present disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment of the invention, application programs 52 in computer 12's memory (as well as software deploying server 36's system memory) may include a graphics application program 60, such as a digital art program that simulates the appearance and behavior of traditional media associated with drawing, painting, and printmaking.

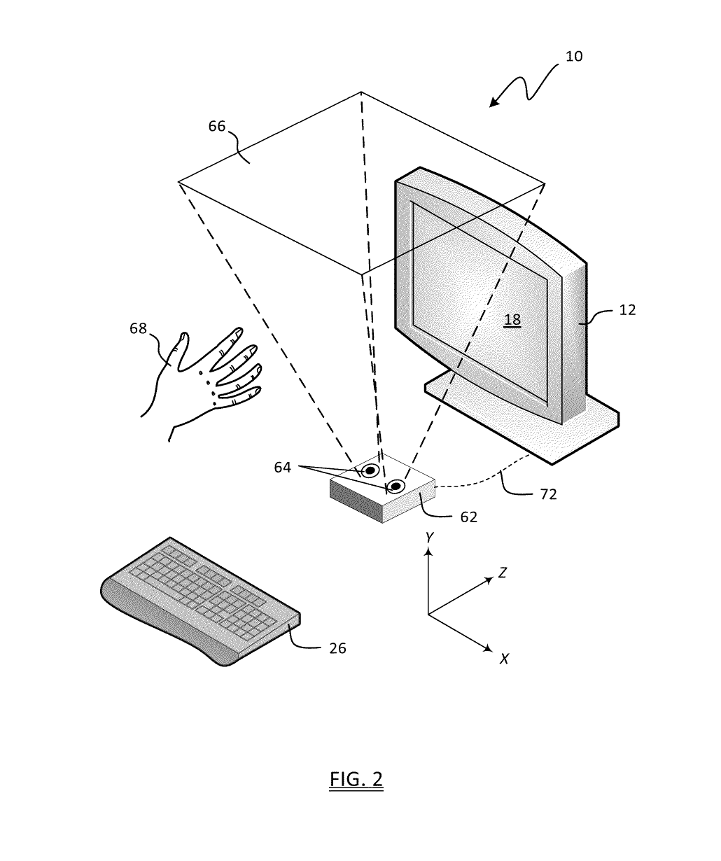

Turning now to FIG. 2, the graphic computer software system 10 further includes a computer vision system 62 as a motion-sensing input device to computer 12. The vision system 62 may be connected to the computer 12 wirelessly via network interface 42 or wired through the USB port 34, for example. In the illustrated embodiment, the vision system 62 includes stereo image sensors 64 to monitor a visual space 66 of the vision system, detect, and capture the position and motion of a tracking object 68 in the visual space. In one example, the vision system 62 is a Leap Motion controller available from Leap Motion, Inc. of San Francisco, Calif.

The visual space 66 is a three-dimensional area in the field of view of the image sensors 64. In one embodiment, the visual space 66 is limited to a small area to provide more accurate tracking and prevent noise (e.g., other objects) from being detected by the system. In one example, the visual space 66 is approximately 0.23 m³ (8 cu.ft.), or roughly equivalent to a 61 cm cube. As shown, the vision system 62 is positioned directly in front of the computer display 18, the image sensors 64 pointing vertically upwards. In this manner, a user may position themselves in front of the display 18 and draw or paint as if the display were a canvas on an easel.

In other embodiments of the present invention, the vision system 62 could be positioned on its side such that the image sensors 64 point horizontally. In this configuration, the vision system 62 can detect a tracking object 68 such as a hand, and the hand could be manipulating the mouse 28 or other input device. The vision system 62 could detect and track movements related to operation of the mouse 28, such as movement in an X-Y plane, right-click, left-click, etc. It should be noted that a mouse need not be physically present—the user's hand could simulate the movement of a mouse (or other input device such as the keyboard 26), and the vision system 62 could track the movements accordingly.

The tracking object 68 may be any object that can be detected, calibrated, and tracked by the vision system 62. In the example wherein the vision system is a Leap Motion controller, exemplary tracking objects 68 include one hand, two hands, one or more fingers, a stylus, painting tools, or a combination of any of those listed. Exemplary painting tools can include brushes, sponges, chalk, and the like.

The vision system 62 may include as part of its operating software a calibration routine 70 in order that the vision system recognizes each tracking object 68. For example, the vision system 62 may install program instructions including a detection process in the application programs 52 portion of memory 48. The detection process can be adapted to learn and store profiles 70 (FIG. 1) for a variety of tracking objects 68. The profiles 70 for each tracking object 68 may be part of the graphics application program 60, or may reside independently in another area of memory 48.

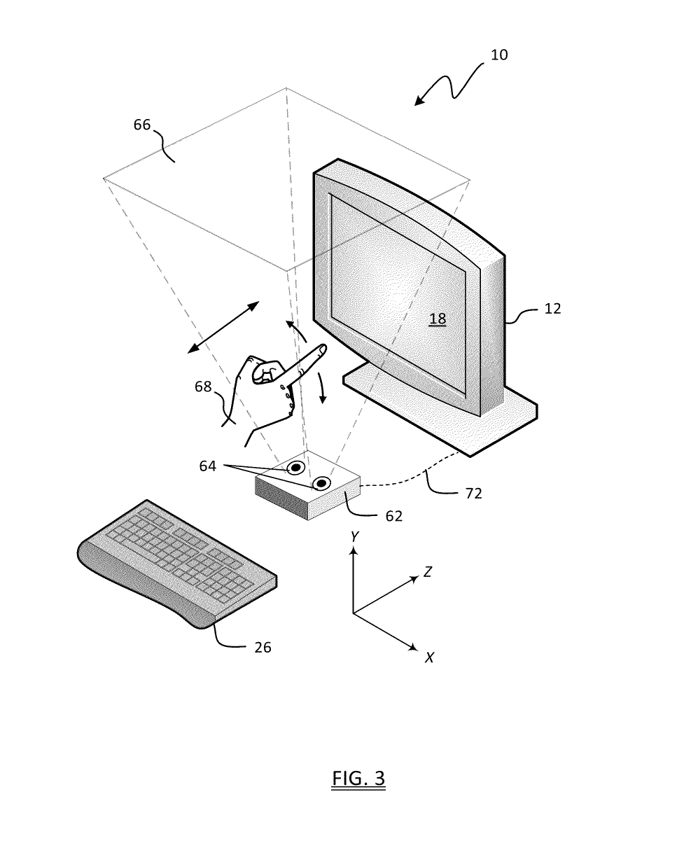

As shown in FIG. 3, insertion of a tracking object 68 such as a finger into the visual space 66 causes the vision system 62 to detect and identify the tracking object, and provide a data stream or spatial coordinate data 72 to computer 12 representative of the location of the tracking object 68 within the visual space 66. The particular spatial coordinate data 72 will depend on the type of vision system being used. In one embodiment, the spatial coordinate data 72 is in the form of three-dimensional coordinate data and a directional vector. In one example, the three-dimensional coordinate data may be expressed in Cartesian coordinates, each point on the tracking object being represented by (x, y, z) coordinates within the visual space 66. For purposes of illustration and to further explain orientation of certain features of the invention, the x-axis runs horizontally in a left-to-right direction of the user; the y-axis runs vertically in an up-down direction to the user; and the z-axis runs in a depth-wise direction towards and away from the user. In addition to streaming the current (x, y, z) position for each calibrated point or points on the tracking object 68, the vision system 62 can further provide a directional vector D indicating the instantaneous direction of the point, the length and width (e.g., size) of the tracking object, and the shape and geometry of the tracking object.

Traditional graphics application programs utilize a mouse or pressure-sensitive tablet as an input device to indicate position on the virtual canvas, and where to begin and end brushstrokes. In the case of a mouse as an input device, the movement of the mouse on a flat surface will generate planar coordinates that are fed to the graphics engine of the software application, and the planar coordinates are translated to the computer display or virtual canvas. Brushstrokes can be created by positioning the mouse cursor to a desired location on the virtual canvas and using mouse clicks to indicate start brushstroke and stop brushstroke commands. In the case of a tablet as an input device, the movement of a stylus on the flat plane of the tablet display will generate similar planar coordinates. In some tablets, application of pressure on the flat display can be used to indicate a start brushstroke command, and lifting the stylus can indicate a stop brushstroke command. In either case, the usefulness of the input device is limited to generating planar coordinates and simple binary commands such as start and stop.

In contrast, the spatial coordinate data 72 of the vision system 62 can be adapted to provide coordinate input to the graphics application program 60 in three dimensions, as opposed to only two. The three dimensional data stream, the directional vector information, and additional information such as the width, length, size, shape and geometry of the tracking object can be used to enhance the capabilities of the graphics application program 60 to provide a more natural user experience.

In one embodiment of the present invention, the (x, y) portion of the position data from the spatial coordinate data 72 can be mapped to (x′, y′) input data for a painting application program 60. As the user moves the tracking object 68 within the visual space 66, the (x, y) coordinates are mapped and fed to the graphics engine of the software application, then ‘drawn’ on the virtual canvas. The mapping step involves a conversion from the particular coordinate output format of the vision system to a coordinate input format for the painting application program 60. In one embodiment using the Leap Motion controller, the mapping involves a two-dimensional coordinate transformation to scale the (x, y) coordinates of the visual space 66 to the (x′, y′) plane of the virtual canvas.

The (z) portion of the position data from the spatial coordinate data 72 can be captured to utilize specific features of the graphics application program 60. In this manner, the (x, y) coordinates could be utilized for a position database and the (z) coordinates could be utilized for another, separate database. In one example, depth coordinate data can provide start brushstroke and stop brushstroke commands as the tracking object 68 moves through the depth of visual space 66. The tracking object 68 may be a finger or a paint brush, and the graphics application program 60 may be a digital paint studio. The user may prepare to apply brush strokes to the virtual canvas by inserting the finger or brush into the visual space 66, at which time coordinate output data 72 begins streaming to the computer 12 for mapping, and the tracking object appears on the display 18. The brushstroke start and stop commands may be initiated via keyboard 26 or by holding down the left-click button of the mouse 28. In one embodiment of the invention, the user moves the tracking object 68 in the z-axis to a predetermined point, at which time the start brushstroke command is initiated. When the user pulls the tracking object 68 back in the z-axis past the predetermined point, the stop brushstroke command is initiated and the tracking object “lifts” off the virtual canvas.

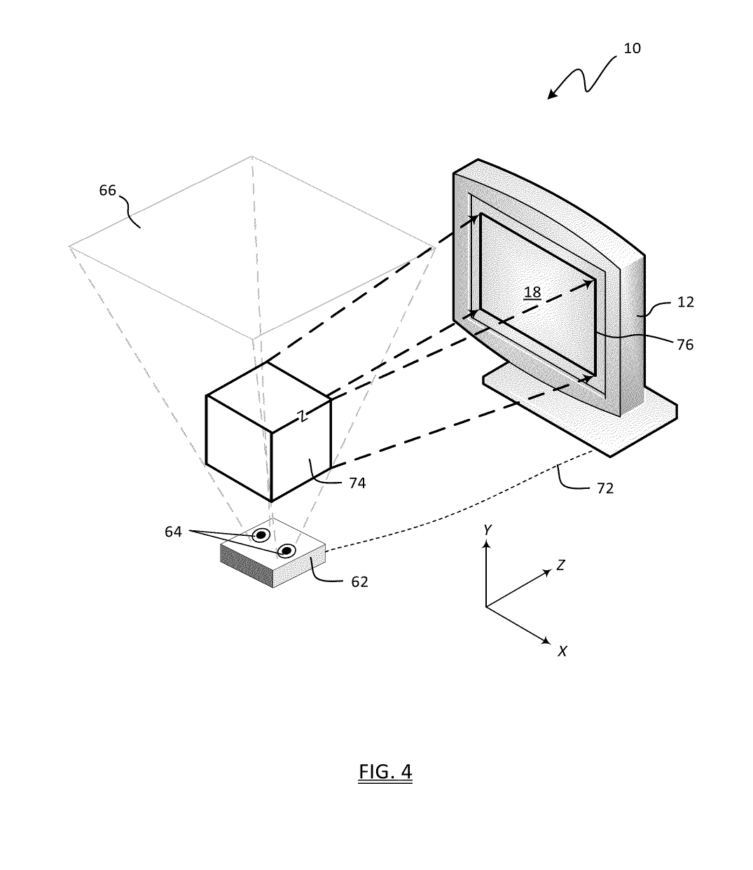

In another embodiment of the invention, a portion of the visual space can be calibrated to enhance the operability with a particular graphics application program. Turning to FIG. 4, the vision system mapping function can include defining a calibrated visual space 74 to provide a virtual surface 76 on the display 18. The virtual surface 76 correlates to the virtual canvas on the painting application program 60. The virtual surface 76 can be represented by the entire screen, a virtual document, a document with a boundary zone, or a specific window, for example. The calibrated visual space 74 can be established by default settings (e.g., ‘out of the box’), by specific values input and controlled by the user, or through a calibration process. In one example, a user can conduct a calibration by indicating the eight corners of the desired calibrated visual space 74. The corners can be indicated by a mouse click, or by a defined gesture with the tracking object 68, for example.

FIG. 5 depicts a schematic front plan view of a calibrated horizontal position 74 in the visual space 66 mapped to the horizontal position in the virtual surface 76. The mapping system may allow control of how much displacement (W) is needed to reach the full virtual surface extents, horizontally. In a typical embodiment, a horizontal displacement (W) of approximately 30 cm (11.8 in.) with a tracking object in the visual space 66 will be sufficient to extend across the entire virtual surface 76. However, the user can select a smaller amount of horizontal displacement if they wish, for example 10 cm (3.9 in.). The center position can also be offset within the visual space, left or right, if desired.

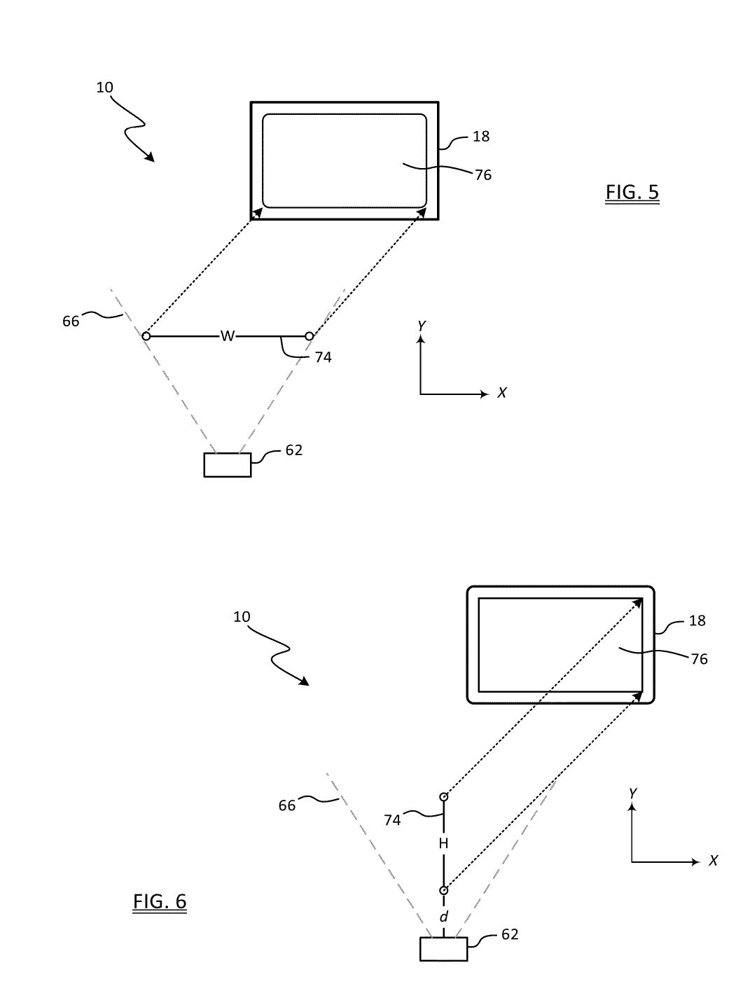

FIG. 6 depicts a schematic front plan view of a calibrated vertical position 74 in the visual space 66 mapped to the vertical position in the virtual surface 76. The mapping system may allow control of how much displacement (H) is needed to reach the full virtual surface extents, vertically. In a typical embodiment, a vertical displacement (H) of approximately 30 cm (11.8 in.) with a tracking object in the visual space 66 will be sufficient to extend across the entire virtual surface 76. The calibrated position 74 may further include a vertical offset (d) from the vision system 62 below which input objects will be ignored. The offset can be defined to give a user a comfortable, arm's length position when drawing.

FIG. 7 depicts a schematic top view of a calibrated depth position 74 in the visual space 66. The calibrated depth position 74 can be calibrated by any of the methods described above with respect to the height (H) and width (W). The depth (Z) of the tracking object 68 in the visual space 66 is not required to map the object in the X-Y plane of the virtual surface 76, and the (z) coordinate data 72 can be useful for a variety of other functions.

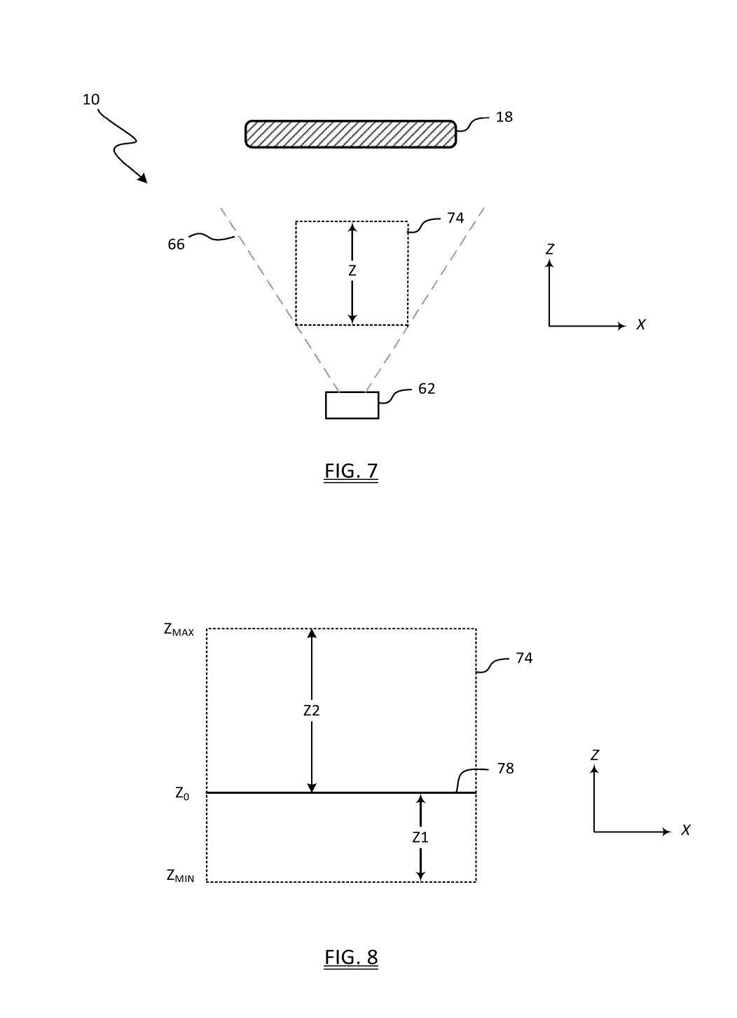

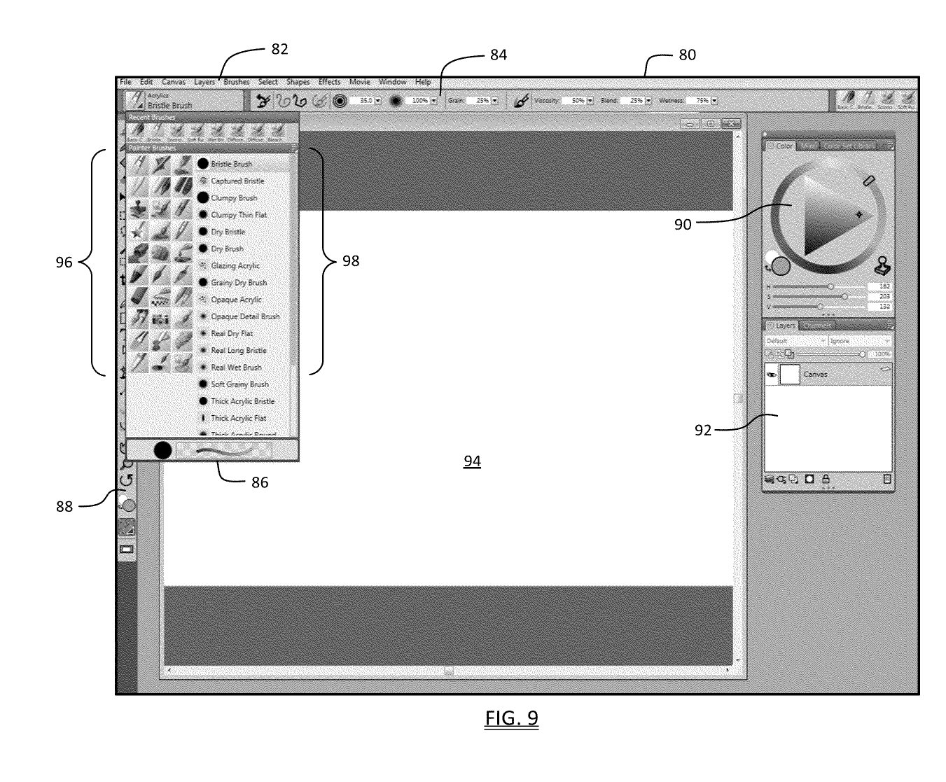

FIG. 8 depicts an enlarged view of the calibrated depth position 74 shown FIG. 7. The calibrated depth position 74 can include a center position Z₀, defining opposing zones Z₁ and Z₂. The zones can be configured to take different actions in the graphics application program. In one example, the depth value may be set to zero at center position Z₀, then increase as the tracking object moves towards the maximum (Z_{MAX}), and decrease as the object moves towards the minimum (Z_{MIN}). The scale of the zones can be different when moving the tracking object towards the maximum depth as opposed to moving the object towards the minimum depth. As illustrated, the depth distance through zone Z₁ is less than Z₂. Thus, a tracking object moving at roughly constant speed will pass through zone Z₁ in a shorter period of time, making an action related to the depth of the tracking object appear quicker to the user.

Furthermore, the scale of the zones can be non-linear. Thus, the mapping of the (z) coordinate data in the spatial coordinate data 72 is not a scalar, it may be mapped according to a quadratic equation, for example. This can be useful when it is desired that the rate of depth change accelerates as the distance increases from the central position.

Continuing with the example set forth above, wherein the tracking object 68 is a finger or a paint brush, and the graphics application program 60 may be a digital paint studio, the user may prepare to apply brush strokes to the virtual canvas by inserting the finger or brush into the visual space 66, at which time coordinate output data 72 begins streaming to the computer 12 for mapping, and the tracking object appears on the display 18. As the user approaches the virtual canvas 76, the tracking object passes into zone Z₁ and the object may be displayed on the screen. As the tracking object passes Z₀, which may signify the virtual canvas, a start brushstroke command is initiated and the finger or brush “touches” the virtual canvas and begins the painting or drawing stroke. When the user completes the brushstroke, the tracking object 68 can be moved in the z-axis towards the user, and upon passing Z₀ the stop brushstroke command is initiated and the tracking object “lifts” off the virtual canvas.

In another embodiment of the invention, the depth or position on the z-axis can be mapped to any of the brush's behaviors or characteristics. In one example, zone Z₂ can be configured to apply “pressure” on the tracking object 68 while painting or drawing. That is, once past Z₀, further movement of the tracking object into the second zone Z₂ can signify the pressure with which the brush is pressing against the canvas; light or heavy. Graphically, the pressure is realized on the virtual canvas by converting the darkness of the paint particles. A light pressure or small depth into zone Z₂ results in a light or faint brushstroke, and a heavy pressure or greater depth into zone Z₂ results in a dark brushstroke.

In some applications, the transformation from movement in the vision system to movement on the display is linear. That is, a one-to-one relationship exists wherein the amount the object is moving is the same amount of pixels that are displayed. However, certain aspects of the present invention can apply a filter of sorts to the output data to accelerate or decelerate the movements to make the user experience more comfortable.

In yet another embodiment of the invention, non-linear scaling can be utilized in mapping the z-axis to provide more realistic painting or drawing effects. For example, in zone Z₂, a non-linear coordinate transformation could result in the tracking object appearing to go to full pressure slowly, which is more realistic than linear pressure with depth. Conversely, in zone Z₁, a non-linear coordinate transformation could result in the tracking object appearing to lift off the virtual canvas very quickly. These non-linear mapping techniques could be applied to different lengths of zones Z₁ and Z₂ to heighten the effect. For example, zone Z₁ could occupy about one-third of the calibrated depth 74, and zone Z₂ could occupy the remaining two-thirds. The non-linear transformation would result in the zone Z₁ action appearing very quickly, and the zone Z₂ action appearing very slowly.

The benefit to using non-linear coordinate transformation is that the amount of movement in the z-axis can be controlled to make actions appear faster or slower. Thus, the action of a brush lifting up could be very quick, allowing the user to lift up only a small amount to start a new stroke.

In the illustrated embodiments, and FIG. 8 in particular, only two zones are disclosed. However, any number of zones having differing functions can be incorporated without departing from the scope of the invention. In this regard, the calibrated visual space 74 may include one or more control planes 78 to separate the functional zones. In FIG. 8, control plane Z₀ is denoted by numeral 78.

In other embodiments of the invention, the (z) portion of the position data from the spatial coordinate data 72 can be captured to utilize software application tools that are used ‘off-canvas’ for the user; that is, the tools used by digital artists that don't actually touch the canvas. Thus, the (x, y, z) portion of the spatial coordinate data 72 can be useful for not only the painting process, but also in making selections. In terms of database storage, the (x, y) coordinates could be utilized for a position database and the (z) coordinates could be utilized for another, separate database, such as a library. The library could be a collection of different papers, patterns, or brushes, for example, and could be accessed by moving the tracking object 68 through control planes in the z-axis to go to different levels on the library database.

FIG. 9 depicts an application window 80 of a graphics application program according to one embodiment of the invention, such as a digital art studio. The primary elements of the application window include a menu bar 82 to access tools and features using a pull-down menu; a property bar 84 for displaying commands related to the active tool or object; a brush library panel 86; a toolbox 88 to access tools for creating, filling, and modifying an image; a temporal color palette 90 to select a color; a layers panel 92 for managing the hierarchy of layers, including controls for creating, selecting, hiding, locking, deleting, naming, and grouping layers; and a virtual canvas 94 on which the graphic image is created. The canvas 94 may include media such as textured paper, fabrics, and wood grain, for example.

The brush library panel 86 displays the available brush libraries 96 on the left-hand side of the panel. As illustrated, there are 30 brush libraries 96 ranging alphabetically from Acrylics at top left to Watercolor at bottom right. Selecting any one of the 30 brush libraries, by mouse-clicking its icon for example, brings up a brush selection 98 from the currently selected brush library. In the illustrated example, there are 22 brush selections 98 from the Acrylic library 96. In total, there may be more than 700 brush styles from which a user may select.

As can be appreciated from FIG. 9, user interface utilities provide graphical navigation for the myriad of selections available to a user for customizing any of the tool's behaviors or characteristics. For example, eight user interface utilities are visible on the application window 80 shown in FIG. 9, and at least six more can be displayed, including user interface utilities for paper type, media library, media control, flow maps, auto-painting, and composition, for example. Although this many user interface utilities can be useful and may be advantageous for certain applications, they suffer from drawbacks. One problem is that the artist may have to frequently stop work on their drawing or painting to navigate the drop-down lists or explore the user interfaces. Such disruption may impede the natural artistic process and subtract from the overall artistic experience, making the digital art studio seem very little like a real art studio. There is therefore a need for user interfaces to be accessed and manipulated in a more natural manner.

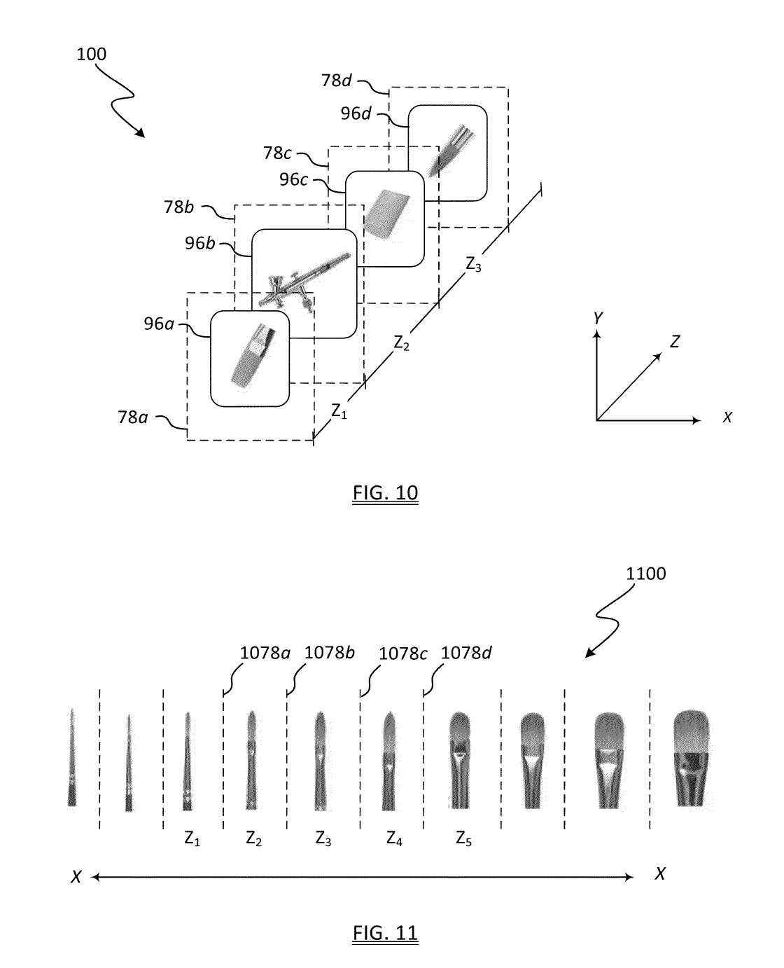

According to one embodiment of the invention, a user interface utility of a graphics application program can be controlled by the movement of a tracking object in the visual space of a vision system. Referring to FIG. 10, a schematic representation of an exemplary user interface utility 100 is shown in perspective view. In this example, the user interface utility 100 provides graphical assistance in choosing a category of brush from the brush library. Icons depict graphical representations of different brush categories, such as an acrylic icon 96a, an air brush icon 96b, a chalk icon 96c, and a watercolor brush icon 96d.

A user of the graphics application program 60 can invoke the user interface utility 100 for the brush library in a conventional manner such as by a keyboard/mouse command, or by a gesture or similar command using the tracking object 68 in the visual space 66.

In one example, the user interface utility 100 renders the icons (e.g., 96a-96d) on the display 18 one at a time. That is, as the tracking object 68 passes from one zone to the next, a single icon can be displayed on the user's computer screen. Referring to FIGS. 3 and 10, as a tracking object 68 occupies the zone Z₁ in the visual space 66, the (z) portion of the spatial coordinate data 72 may be mapped to the acrylic brush category and the acrylic icon 96a is displayed on the computer screen 18. As the tracking object 68 moves deeper into the z-direction and crosses control plane 78b into zone Z₂, the (z) portion of the spatial coordinate data 72 is mapped to the air brush category and the air brush icon 96b is displayed on the computer screen 18. Further movement of the tracking object 68 in the z-direction eventually crosses control plane 78c into zone Z₃, the (z) portion of the spatial coordinate data 72 is mapped to the chalk category, and the chalk icon 96c is displayed on the computer screen 18. This mapping of the spatial coordinate data 72 to the brush category can continue for any number of zones.

In one example, upon arriving at the desired brush category, the user can select it by, for example, a keyboard shortcut, a gesture, or a timer. The timer selection could be invoked by meeting a threshold of (non-) movement to determine if the user is pointing at the same selection for a short amount of time (e.g., ¾ seconds), at which point the brush category is selected.

In another example, the user interface utility 100 renders more than one icon on the display 18 at a time, depending on the location of the tracking object in the visual space. In one implementation, the icons (e.g., 96a-96d) are stationary but fade into view and out of view on the display 18 as the tracking object 68 moves through the depth of the visual space 66. The rendering of the user interface utility 100 on the display 18 could appear to have depth, much like that shown in FIG. 10. If the tracking object 68 was positioned in the depth axis within the boundaries established for zone Z₂, for example, the air brush icon 96b is fully visible (e.g., 100% opacity). Being closest to the active icon 96b, the icons for the acrylic brush 96a and chalk 96c could be rendered visible, but faded, with approximately 25% opacity. Icons farther removed, such as watercolor brush icon 96d, could be rendered barely visible, with approximately 10% opacity.

In one example, the icons could become animated as the tracking object moves within the (z)-axis, moving forward or backward in a chain. One possible implementation of the animated effect is to map the (z)-portion of the spatial coordinate data 72 to a scrolling effect. The depth portion of the calibrated visual space 74 may be divided into two zones Z₁ and Z₂, delineated by a control plane 78 (FIG. 8). When the tracking object is positioned at the control plane 78, the velocity of the scrolling speed can be set to a value of zero. Movement of the tracking object into and out of the depth of zones Z₁ and Z₂ could map the coordinate data 72 to a scroll velocity and direction. The scroll velocity could be a constant value, or may increase linearly (or otherwise) with the depth coordinate in each zone. Thus, referring to FIGS. 8 and 10, the depth coordinate at the control plane 78 could be mapped to a zero value scroll velocity. As the tracking object moves deeper into zone Z₂ away from the control plane 78, the chain of icons 96a-96d could scroll or animate into the depth of the z-axis at an increasing scroll velocity. As the tracking object moves deeper into zone Z₁ away from the control plane 78, the chain of icons 96a-96d could scroll or animate out of the depth of the z-axis (towards the user) at an increasing scroll velocity. When the scroll velocity is non-linear, a small displacement in the z-direction results in slow animation, but as the distance from the control plane 78 is increased, the animation accelerates more quickly.

In addition, the relative position of the icon receiving focus (e.g., fully visible) could remain the same on the display 18 or in the confines of the graphical user interface utility 100, while the zones, which are not visible to the user, could march forward. For example, the graphical user interface utility 100 could appear on a display as shown in FIG. 10. The relative position of UI 100 would not change, but zones Z₁, Z₂, Z₃ and their associated icons 96a, 96b, and 96c would move forward receiving full visibility and then fading out.

The user interface utility may be controlled by spatial coordinate data 72 other than the depth or (z)-portion of the data. Referring now to FIG. 11, a user interface utility 1100 may be controlled by the (x)-portion of the spatial coordinate data 72. In one embodiment, after the brush category is selected using the depth coordinate data 72 described above, and the types of brushes within that category can be displayed by moving the tracking object 68 in a sideways motion from left to right and vice versa. In the illustrated example, the acrylic icon 96a is selected in the user interface utility 100, and user interface utility 1100 displays icons such as 1096a-1096d for the different types of acrylic brushes. Vertical control planes, such as planes 1078a-1078d, can be established in the visual space 66 to delineate between the brush types. Sideways movement of the tracking object 68 will cross through the control planes and a different type of brush icon can be displayed.

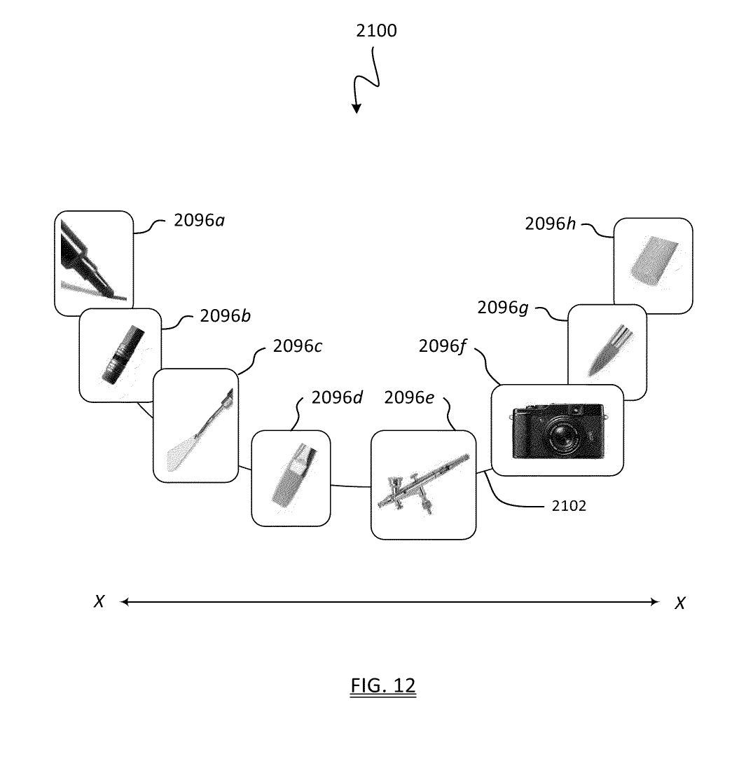

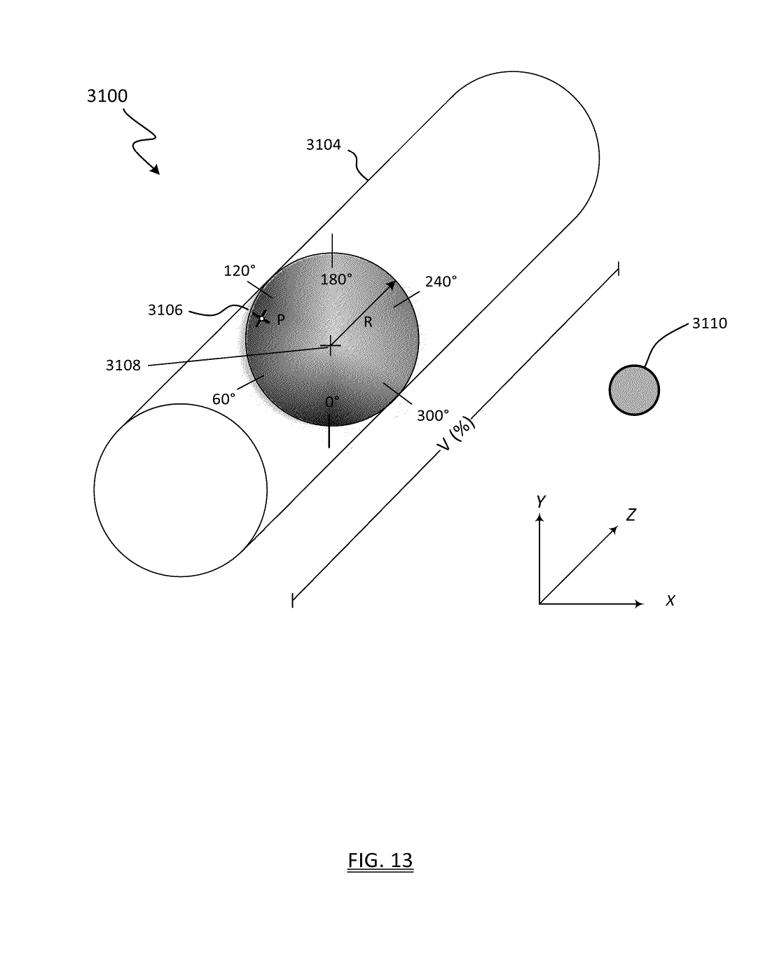

FIG. 12 depicts a user interface utility 2100 according to another embodiment of the invention in which a curved animation path replaces the linear animation described in reference to the (z)-axis in FIG. 10 and the (x)-axis in FIG. 11. This embodiment is particularly useful when the list of available objects from which to select is long (e.g., more than six). In the illustrated embodiment, the icons scroll along an arc 2102 or similar curved path. The user may swipe a tracking object such as a hand or finger in a sideways manner along the (x)-axis in the visual space, and the user interface utility 2100 appearing on the display of the computer system animates the icons to move along the arc 2102. The program instructions for the UI 2100 may instruct an icon to visually appear at one side of the arc, follow the path of the arc, then disappear at the other side of the arc. If the user swipes the tracking object in the opposite direction, the icons may appear and disappear in the reverse order.

In another example, the (x)-portion of the spatial coordinate data 72 may be mapped to the scroll velocity of the chain of objects. This example can be applied in the same manner as the scroll velocity for the depth axis in FIG. 10 or the horizontal axis in FIG. 11, wherein a central control plane is mapped to a zero value scroll velocity and movement by the tracking object to either side of the control plane can increase the scroll velocity. Thus, the illustrated embodiments disclose that the chain of icons could be rendered left-right, up-down, using a perspective view, or in a circular fashion. Furthermore, the chain of icons could ‘wrap around’ and scroll in an infinite loop, or the animation could stop once the last object becomes in focus.

In a similar variation, the (y)-portion, the (z)-portion, or any combination of the (x)-portion, the (y)-portion, and the (z)-portion of the spatial coordinate data 72 may be mapped to the icons. For example, the motion of the tracking object in the visual space may be radial or curved rather than linear to impart a more natural movement from a user's arm or hand. Using the natural movements of the human body as opposed to strictly linear movements may provide the artist with a more natural experience, as well as alleviate stress in the joints and prevent nerve compression syndrome, such as carpel tunnel.

In operation, the user interface utility 2100 may be activated by a keyboard/mouse command, or by a gesture or similar command using the tracking object 68 in the visual space 66. Similar to the embodiment set forth in reference to FIG. 10, the user interface utility 2100 provides graphical assistance in choosing a category of brush from the brush library. Icons depict graphical representations of different brush categories, and may include, starting from the left side of the graphic, a markers icon 2096a, an eraser icon 2096b, a palette knives icon 2096c, an acrylic brush icon 2096d, an air brush icon 2096e, a photo icon 2096f, a watercolor brush icon 2096d, and a chalk icon 2096h. As noted in FIG. 9, there may be 30 or more brush categories in the library, but only a portion of them are initially rendered in the UI 2100. As the user swipes the tracking object in a sideways motion in the visual space, the icons will ‘spin’ along the path of the arc 2102, coming into and going out of view. In this manner, there is virtually no limit to the number of objects that can be displayed.

Various combinations of the disclosed embodiments are envisioned without departing from the scope of the invention. For example, a brush category may be selected as described in reference to FIG. 10, and the types of brushes within each category may be selected according to the principles described in reference to the user interface utility 2100 shown in FIG. 12.

Although the description of the user interface utilities 100, 1100, and 2100 depict selection of a brush from a brush library, many other tools, features, and resources of the graphics application program 60 may be selected using the inventive user interface utility. For example, a paper library could be displayed, allowing the user to select different types of virtual paper for the drawing.

In another example, referring to FIG. 9, any of the disclosed user interface utilities 100, 1100, and 2100 could display a list of icons for the toolbox 88, such as Brush Tool, Dropper, Paint Bucket, Eraser, Layer Adjuster, Magic Wand, or Pen, to name but a few. The user could scroll through the list by moving the tracking object in the visual space. Once a toolbox icon is selected, any of the user interface utilities 100, 1100, and 2100 could be used to display and allow selection from the options for each tool.

Turning to FIG. 13, in another embodiment of the invention, movement of a tracking object in the visual space could control a user interface utility 3100 that selects or modifies a color from the color palette. In the illustrated embodiment, a cylindrical color space is graphically represented by a three-dimensional cylinder 3104 that includes Hue, Saturation, and Value (HSV) components. The Hue can be defined as pure color or the dominant wavelength in a color system. Hue is represented in FIG. 13 by the angular position 3106 on the outer color ring. The Hue spans a ring of colors including the primary colors, their complements, and all of the colors in between: spanning in clockwise circular motion from bottom dead center, the Hue varies from blue to magenta, to red, to yellow, to green, to cyan, and back to blue. Thus, in the illustrated embodiment, blue is located at 0°, magenta is at 60°, red at 120°, yellow at 180°, green at 240°, and cyan at 300°.

The Saturation component of the HSV color space can be described as the dominance of hue in the color, or the ratio of the dominant wavelength to other wavelengths in the color. The color palette GUI 3100 shown in FIG. 13 represents Saturation by the radial distance (shown as vector R) from the center point 3108 to the edge of the cylinder.

The component Value can be described as a brightness, an overall intensity or strength of the light. In the illustrated embodiment, the Value component (V %) is represented along the depth axis (Z) of the cylinder 3104.

In operation, the user can choose or modify a color within the graphics application program 60 using the inventive interface utility 3100 disclosed herein. Referring to FIGS. 3 and 13, the user can invoke the user interface utility 3100 either by a conventional keyboard/mouse command, or by a gesture or similar command with the tracking object 68 in the visual space 66, for example. Then, the color point P in the utility 3100 may be altered based on movements of the tracking object 68 in the visual space 66 of the vision system 62. To select the Hue component of the HSV color space, the user can trace an imaginary circle in the visual space 66 with the tracking object 68, which could be the user's index finger, and the (x, y) coordinates of the spatial coordinate data 72 are mapped to an angular position 3106 on the color wheel using polar coordinates. The Saturation component can be selected by radial movements by the tracking object 68 in the visual space 66 (shown as vector R), also mapping (x, y) and polar coordinates. The radial distance from the center point 3108 of the cylinder to the edge of the cylinder can define the range of Saturation values. A tracking object such as a finger located at the center point 3108 can represent complete desaturation (e.g., 0% saturation level), and a finger located on the outer circumference can represent full saturation (e.g., 100% saturation level).

The Value component of the HSV color space can be defined by the movement of the tracking object 68 in the depth or z-axis of the visual space 66. The depth portion of the spatial coordinate data 72 may be mapped to a depth position on the three-dimensional cylinder 3104.

Thus, the position P in this example is a result of (x, y) coordinates from the vision system mapped to Saturation and Hue components using polar coordinates, and (z) coordinates mapped to the Value component. A separate graphic display 3110 within the interface utility 3100 may show the current (e.g., real-time) color scheme as configured by the user. Upon arriving at the desired components of Hue, Saturation, and Value, the user can lock them in by, for example, a keyboard shortcut, a gesture, or a timer. The timer selection could be invoked by meeting a threshold of (non-) movement to determine if the user is pointing at the same selection for a short amount of time (e.g., ¾ seconds), at which point the color selection is locked.

One advantage of mapping the spatial coordinate data 72 to the color space utility 3100 is that the extent of several attributes can be discerned visually at one time, in three dimensions. In the example of cylindrical color space, the depth component of the cylinder provides the user with a visual indication of the extent to which the attribute is set (in this case, the Value component). The additional visual information in the depth dimension can therefore provide the user with a graphic representation of both their current position and some kind of indicator of their relative position along the entire scale. In other words, a sense of where they are and how much ‘room’ is left to effect a change. The illustrated embodiment shown in FIG. 13 shows the user a point P indicating the Hue component is approximately at 100°, the Saturation component is approximately 80%, and the Value component is approximately 50%. The corresponding composite color for those settings can be shown in the graphic display 3110.

Typical color space UI utilities do not provide a real-time mechanism or process to view the interaction of the individual components. Typically, only one, and sometimes two, color components can be manipulated at the same time, with the final results being shown in a graphic such as display 3110. In this manner, color adjustment is an iterative process. In contrast, the mapping of the three-dimensional vision space to a three-dimensional color model can provide real-time color adjustment and verification in one step.

The embodiment of a user interface utility 3100 disclosed in FIG. 13 was a cylindrical color space model. Other user interface utilities of color space models are contemplated within the scope of the invention. For example, a custom user interface utility receiving mapping coordinates from the vision system could include a conical color space, red-green-blue (RGB), CIELAB or Lab color space, YCbCr, or any other color space. Each color space can have different types of mapping and user interface depending on the shape and configuration of the color space itself. As described above, HSV is often represented as a conical or cylindrical color space, and the user interface utility may include a color ring receiving polar coordinates to map the (x, y) coordinates to the Hue component. If an alternate color space is used, such as an RGB cubic color space, (x, y) coordinates could be mapped to any of the RG, GB, or RB spaces formed by combinations of two of the RGB axes. The user interface utility may depict the RGB color space as a cube, and the user may be provided a visual graphic of the tracking object's current location within the cube. Using three dimensional coordinates, the (x, y, z) coordinates could be mapped to RGB: the position on the x-axis could be mapped to the Red component, the position on the y-axis could be mapped to the Green component, and the position on the depth or z-axis could be mapped to the Blue component, for example.

The disclosed user interface utilities provide the capability to display a very large number of objects from which the user may select. In some circumstances, for instance in choosing a color or an object from a very large library of objects, the user may benefit from higher granularity in the selection menu to distinguish between similar objects. In one embodiment of the invention, a user interface utility utilizes the spatial coordinate data output by the vision system to display a course selection menu and a fine selection menu. In one example, a user interface utility 2100 such as that illustrated in FIG. 12 can display, in animated fashion, a long list of brush libraries. The depicted segment shows brush libraries 2096a-2096a, but there may be 30 or more brush libraries in a graphics application program. The brush libraries may be referred to as the course menu. Selecting one of the icons can bring up the fine menu, which in one example are the brush categories. In one implementation, the tracking object can stop movement in the x-y direction to cease course menu selection, then move into the z-direction for the fine menu selection.

In another example, the course/fine menu selection of objects can be implemented in choosing a color on a color wheel. Often, an artist using a graphics application program is not choosing between yellow or blue or green, they are choosing a basic color like yellow and need a slightly different shade of that color. Referring to FIG. 9 for example, a color palette 90 user interface utility could be activated, and a course selection of the Hue component could be selected by any of the methods disclosed herein. The user could then select a fine menu by moving the tracking object into the z-direction, for example, to zoom in on the particular quadrant of the color wheel. The depth distance of the tracking object in the visual space could be mapped to the zoom feature. In this manner, the user is provided a sub-menu of progressively higher granularity of the different color shades surrounding a primary color choice. The zoom feature could be utilized for the selection of Saturation and Value components as well. Mapping the spatial coordinate data to a sub-menu via a zoom feature, for example, could also be utilized on the color wheel depicted in FIG. 13.

In another example, a user interface utility for the graphics application program utilizes the spatial coordinate data output by the vision system to perform tool adjustments. The tool adjustments can be for static or default tools settings, as opposed to dynamic adjustments made while a user is painting or drawing. In one example, the user interface utility is invoked from a gesture, keyboard shortcut, or a “point and wait” over a specified area. Once invoked, the spatial coordinate data from the vision system can be used to control certain aspects of the tool. For example, (x,y) data can be converted to polar coordinates, and the radial distance from the center or point of reference can be mapped to the brush size. In another example, the (z) data is mapped to control the opacity of the tool. Opacity may increase as the tracking object moves forward, and opacity may decrease as the tracking object is pulled back. Other spatial coordinate data provided by the vision system can also be used. For example, tilt or bearing of your tracking object can be used to adjust the default angle of the tool. And, more than one input could be used to control certain aspects of the tool. For instance, the distance between two tracking objects could be mapped to control the amount of squeeze on the tool, making adjustments to the roundness of the marks that the tool would create by default.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A method for controlling a user interface utility in a graphics application program executing on a computer, comprising the steps of:
connecting a vision system to the computer, the vision system adapted to monitor a visual space;
detecting, by the vision system, a tracking object in the visual space;
executing, by the computer, a graphics application program;
outputting, by the vision system to the computer, spatial coordinate data representative of the location of the tracking object within the visual space; and
controlling, with the spatial coordinate data output by the vision system, the rendering of a user interface utility within the graphics application program to a display connected to the computer.

2. The method according to claim 1, wherein the spatial coordinate data from one axis are mapped to the graphics application program to control the user interface utility.

3. The method according to claim 2, wherein a horizontal portion of the spatial coordinate data is mapped to the graphics application program to control the user interface utility.

4. The method according to claim 3, further comprising the step of establishing vertical control planes in the visual space to delineate a plurality of control zones along the horizontal axis.

5. The method according to claim 4, further comprising the step of displaying a plurality of user-selectable objects in the user interface utility associated with one or more of the control zones in the visual space.

6. The method according to claim 5, wherein the object is an icon.

7. The method according to claim 2, wherein a depth portion of the spatial coordinate data is mapped to the graphics application program to control the user interface utility.

8. The method according to claim 7, further comprising the step of establishing control planes in the visual space to delineate a plurality of control zones along the depth axis.

9. The method according to claim 8, further comprising the step of providing a user-selectable object in the user interface utility associated with one of the control zones in the depth axis of the visual space.

10. The method according to claim 9, further comprising the step of displaying a plurality of user-selectable objects associated with the control zones in the depth axis of the visual space.

11. The method according to claim 1, further comprising the steps of:
establishing control planes in the visual space to delineate a plurality of control zones;
displaying a plurality of user-selectable objects in the user interface utility associated with the control zones; and
animating the display of user-selectable objects in relation to the location of the tracking object within the visual space.

12. The method according to claim 11, wherein the animation of the user-selectable objects is linear.

13. The method according to claim 11, wherein the animation of the user-selectable objects is along an arc.

14. The method according to claim 11, wherein a velocity of the animation is controlled by the location of the tracking object within the visual space.

15. The method according to claim 1, wherein the spatial coordinate data from more than one axis are mapped to the graphics application program to control the user interface utility.

16. The method according to claim 15, wherein a horizontal portion and a vertical portion of the spatial coordinate data are mapped to the graphics application program to control the user interface utility.

17. The method according to claim 15, wherein the spatial coordinate data from a horizontal portion, a vertical portion, and a depth portion of the spatial coordinate data are mapped to the graphics application program to control the user interface utility.

18. The method according to claim 17, wherein the user interface utility is a graphical representation of a color space.

19. A graphic computer software system, comprising:
a computer, comprising:
one or more processors;
one or more computer-readable memories;
one or more computer-readable tangible storage devices; and
program instructions stored on at least one of the one or more storage devices for execution by at least one of the one or more processors via at least one of the one or more memories;
a display connected to the computer;
a tracking object; and
a vision system connected to the computer, the vision system comprising one or more image sensors adapted to capture the location of the tracking object within a visual space, the vision system adapted to output to the computer spatial coordinate data representative of the location of the tracking object within the visual space;
the computer program instructions comprising:
program instructions to execute a graphics application program and output to the display; and
program instructions to control the rendering of a user interface utility within the graphics application program using the spatial coordinate data output by the vision system.

20. The graphic computer software system according to claim 19, wherein the program instructions use spatial coordinate data from one axis of the vision system.

21. The graphic computer software system according to claim 19, wherein the program instructions further include establishing control planes in the visual space to delineate a plurality of control zones along an axis of the visual space, and displaying a plurality of user-selectable objects in the user interface utility associated with one or more of the control zones.

22. The graphic computer software system according to claim 19, wherein the program instructions use a horizontal portion, a vertical portion, and a depth portion of the spatial coordinate data of the vision system to render the user interface utility.

23. The graphic computer software system according to claim 22, wherein the user interface utility is a graphical representation of a color space.

24. The graphic computer software system according to claim 23, wherein the color space is selected from the group comprising a conical color space, a cylindrical color space, and a cubic color space.
